(19) United States
(12) Patent Application Publication
(10) Pub. No.: US 2012/0047169 A1
(43) Pub. Date: Feb. 23, 2012

(54) System for Replication and Delivery of Remote Data and Accumulated Metadata with Enhanced Display

(76) Inventors: B. Steven Schroeder, Chicago, IL (US); Hieu Ta, Hayward, CA (US)

(21) Appl. No.: 13/166,698

(22) Filed: Jun. 22, 2011

Related U.S. Application Data
(60) Provisional application No. 61/360,491, filed on Jun. 30, 2010.

(51) Int. Cl. G06F 17/30

(52) U.S. Cl. 707/770; 707/E17.014

(57) ABSTRACT

A delivery platform delivers data from a remote data source to an application on a mobile device. In response to requests from the application, the delivery platform retrieves the data from a remote data source and stores it in a local database. Corresponding metadata is stored in a metadata database. The delivery platform delivers to the application a view of the retrieved data that is based on the retrieved data stored in the local database and on the metadata stored in the metadata database.

### CROSS-REFERENCE TO RELATED APPLICATION(S)

This application claims priority under 35 U.S.C. §119(e) to U.S. Provisional Patent Application Ser. No. 61/360,491, “System for Replication and Delivery of Remote Data and Accumulated Metadata with Enhanced Display,” filed Jun. 30, 2010. The subject matter of the foregoing is incorporated herein by reference in its entirety.

### BACKGROUND OF THE INVENTION

1. Field of the Invention

This invention relates generally to the storage, replication, and delivery of data provided by a remote data source, but altered into a modified view and made available to a mobile device.

2. Description of the Related Art

Conventional data synchronizing solutions focus on synchronizing, or “syncing,” data from a device to a cloud storage and back to the device.

This solution focuses on a master source of data, or multiple sources of data, replicated to the device.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 is a diagram showing one embodiment of system including a delivery platform and communication between components of the system according to the invention.

### TERMS

Delivery platform—a system comprising various servers that cache, store and distribute data to device clients and applications on those devices.

Mobile device—a client device or mobile terminal that connects wirelessly to the system through a mobile or wireless network, using one or more wireless protocols.

Application—computer-executable instructions stored on a tangible computer-storage medium included in a mobile device, for displaying and interacting with data made available by the system.

Remote data source—a remote data source available either within the delivery platform, or externally available via the public Internet or a private network, including the primary source of data to be viewed by a mobile client.

Delivery server—a server within the delivery platform, responsible for connections and delivery of data to the device clients and one or more applications.

Identity service—server that manages the registration and authentication of user identites and authentication information with remote data services.

Identity database—a database that stores the user identity and authentication information of remote data services.

Local database—a database (disk or in memory) within the delivery platform that stores information retrieved from a remote data source, fully intact to maintain the integrity of the source data. In one embodiment, data stored in the local database is “read-only,” allowing the stored data to be retrieved but not modified.

Metadata database—a database (disk or in memory) within the delivery platform that stores accumulated metadata and any additional data that is not kept within the remote data source or the local database. In one embodiment, data stored in the metadata database is able to be modified, or is “editable.” Data stored in the metadata database describes local data created within the delivery platform.

Combined view—a customized view of data within the local database (from the remote data source) that has been modified based on properties or additional data provided from the metadata database. The combined view is an altered view of the remote data, created as a result of metadata that has been created within the system.

Unique key—a unique key that identifies a single record within the local database, typically comprised of a key inferred from composite data fields provided by the remote data source, or created by the system.

### DETAILED DESCRIPTION OF THE PREFERRED EMBODIMENTS

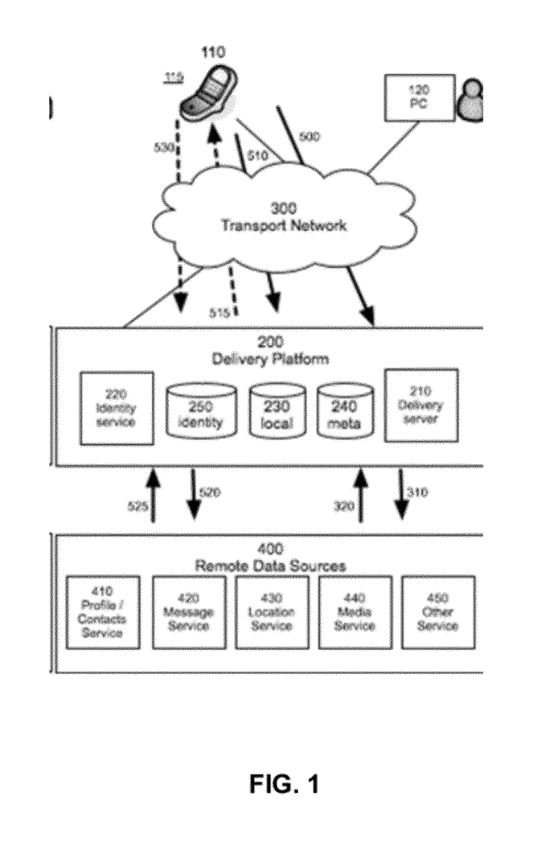

FIG. 1 is a diagram showing one embodiment of system including a delivery platform and communication between components of the system according to the invention. The system components and interaction are described further below. The system shown by FIG. 1 depicts an example case of the storage, replication and delivery of remote data and accumulated metadata according to the invention. The invention can span multiple networks including public internet 100 and a mobile transport network 300.

The example shown by FIG. 1 includes a mobile device 110 executing an application 115 that renders data to the end user. Data rendered to the end user has come from one or more remote data sources 400, and optionally includes data stored on the mobile device 110. The mobile device 100 connects to the delivery platform 200 and specifically the delivery server 210 that aggregates data from the data sources 400 and delivers a view to the application 115. An identity service 220 exists to manage authentication information to the remote data source 400. Additional servers may exist coupled loosely or tightly with the delivery server 210 for the purpose of interacting with the remote data source 400. In either case, data retrieved from the remote data source 400 will be stored in a local database 230. A metadata database 240 is present to store additional data accumulated with data retrieved from the remote data source 400. The local database 230 and metadata database 240 can be logically and physically one database or multiple databases and additional span multiple servers, as required for specific performance characteristics of the system. The local database 230 and metadata database 240 can be an in memory database, a traditional relational database, or a key value pair database. Many types of databases can be used in the system.

The mobile device 110 is connected to a mobile network and may communicate with the delivery platform 200 over the mobile transport network 300 using a variety of protocols, such as GSM, CDMA, W-CDMA, Wifi, WiMax, LTE or another wireless protocol. The mobile transport network 300 could refer to a 2G or 3G mobile network or the public internet. The application 115 resides on the mobile device 110, and may be a downloaded or pre-installed application or linked to the software running native applications on the device.

In one embodiment, the user may use the application 115 to interact with information displayed using the application 115. This information is typically stored on a remote data source 400. The end user typically will have a separate account for each remote data source 400, to identify and secure his information. Typically this information is secured with a standard username/password but many open standards are now available for securing this data, such as Microsoft Open ID, Facebook Connect or any other suitable open standard.

Note that the term remote data source 400 can also refer to data sources within the system or on the local device, such as a user's mobile contacts on the device.

As part of initialization of the application 115, the end user registers the remote data source 400 with the delivery platform 210. The delivery platform 210 authenticates end user credentials against the remote data source 400 and stores the authentication information or a security token in the identity database 250. Several standard authentication methods are available for this, including standard username/password authentication and OAUTH for a more secure method.

The application 115 issues a connection request 500 to the delivery platform 200, and specifically the delivery server 210. In response to this request, the delivery server 210 or identity service 220 issues an authentication request 310 to the remote data source 400 with credentials or the authentication token stored in the identity database 250. The remote data source 400 issues an authentication response 320 indicating the success or failure of the request. Typically the authentication response 320 contains an authentication token to be used in subsequent requests for API data. Depending on the authentication scheme used with the specific data source, in some cases this step is not necessary and the authentication token from previous authentication requests can be stored and sent in subsequent data request messages 520.

In other cases, a more complex 3-step authentication scheme is used. Alternatively, credentials can be stored on the mobile device 110 or within the application 115, and passed to the delivery platform 200 as part of the data request. A connection request 500 and subsequently the authentication request 310 can be initiated on behalf of the end user when the mobile device 110 is powered on, when the remote data source 400 is registered with the system by the application 115, or when a specific application 115 is initiated on the device. Any combination of these options is also possible and the system may periodically authenticate with the remote data source 400 independently of these actions to refresh data on behalf of the user.

After the connection is established between the application 115 and the delivery server 210, the delivery server 210 is able to retrieve data from the remote data source 400. The delivery server 210 can retrieve an initial set of information after the connection request 500 or in response to a specific data request message 510. The delivery server 210 makes a remote data call 520 to the remote data source 400, and receives a remote data response 525. The remote data call 520 and remote data response 525 can be issued using a variety of web or network protocols, including, but not limited to, HTTP, TCP, UDP, RMI, JMS or similar method. The remote data response 525 formats the data using a variety of data protocols such as XML, JSON, and can be text or binary data in a variety of other formats. Public APIs may be available for accessing available information from the remote data source 400. In some cases, private APIs may be made available to retrieve data from these sources. The information retrieved from the remote data source 400 and stored by the delivery platform 200 within the local database 230 are relatively temporary and may be deleted and refreshed with new data from the remote data source 400 at any point.

The data returned in the remote data response 525 is stored in a local database 230. In one embodiment, data returned in the remote data response 525 is transient and may be deleted and refreshed at any time. Examples of data that may be retrieved include user contact records, electronic messages, content items such as images, videos, news articles, blog posts and other data. Other types of data are possible that are stored in a remote data service and typically accessed via the Internet but in this system the data will be made available to an end user on a mobile device 110.

In order to uniquely identify the data records in the local database 230, a unique key is inferred from composite data fields returned from the remote data source 400 in the remote data response 525. This is important to uniquely identify each record of data that has been retrieved. Examples of data that can be used to develop a unique key are: data source identifier which is unique to the specific data source, user identifier which is unique to the user's account, timestamp, subject or message text, record id or other representation made available from the remote data source 400. The information used to identify the record will depend on the specific data source and information being retrieved by the system. Additionally, a hash function is typically be used to create a unique key using the composite data fields mentioned above, though this is not required.

The remote data response 525 is stored in a manner that maintains the integrity of the source data, using the unique key, and ensuring that the data may be deleted and refreshed by the system at any point in time without impacting the integrity of the system as a whole.

Periodically, new data sets are retrieved from the remote data source 400 by sending a new remote data call 520 and receiving a remote data response 525. This can be based on user behavior, time scale, or from notifications of changed data from the remote data source. Typically the most recent data set is returned in the remote data response 525; however, often the remote data call 520 includes parameters that determine the number of records, or the specific data set to be returned based on specific parameters, either provided by the end user or inferred by the system based on user behavior. Specific parameters depend on the specific remote data source 400 being accessed but could have time parameters related to specific data sets, keyword search parameters, tags, or other parameters typical in retrieving information from a remote data source. The remote data call 520 is implicitly through startup or login or connection request of the application 115, or explicitly through specific user actions such as attempting to view specific sets of data.

The data request message 510 and data request response 515 between the application 115 and the delivery server 210 is decoupled from the remote data call 520 and remote data response 525 between the delivery server 210 and the remote data source 400. Typically, the data request message 510 and data request response 515 is an asynchronous request response while the remote data call 520 and remote data response 525 are typically synchronous request responses. While this is not always the case, the advantage of this approach is that the delivery server 210 provides a fast data request response 515 to the application 115, with data that is already available within the delivery platform 200. Meanwhile, the delivery platform 200 can initiate a remote data call 520 and remote data response 525 to refresh the information available in the system, and send a new data request response 515 to the application client 115 with the updated data for viewing. Additionally, by using an asynchronous request response for the data request message 510 and data request response 515, the application 115 can allow the end user to continue processing other tasks while waiting for the data request response 515 from the delivery server 210. Additionally, if the data request message 510 and request message response 515 are not decoupled from the remote data call 520 and the remote data response 525, the end user will experience a significant lag in information display from the server which must be retrieved from the remote data source 400.

During operation of the application 115, metadata is accumulated within the user session by the application, and sent to the delivery platform 200 by sending a session metadata message 530. This session metadata 530 is stored in the metadata database 240. Examples of information accumulated by the application 115 are, viewing a record, merging a record, deleting a record, creating a message associated with a record, creating specific associations between records, tagging keywords on a record, adding text or other data field attribute and value, or applying other information to a specific record, such as location information, a timestamp, association with another record of similar or other type, or other contextual data to be stored and associated with a specific record stored in the local database 230. This metadata is to be used in conjunction with the data stored in the local database 230 that was retrieved from the remote data source 400 in the remote data response 525. This metadata references one or more data sets stored in the local database 230 by referencing the unique key. The delivery server 210 combines data elements from the local database 230 and the metadata database 240 to provide a unified view of the data to the end user, via the application 115 and the mobile device 110. Metadata may provide information about the context of the data, or relationships between two data sets that exist in the local database 230. In some instances, specific rules are applied and stored as metadata as data is retrieved from the remote data source and stored by the system in the local database 230.

One specific example of accumulated metadata is the relationship between two contact records from multiple data services. In this case, a user has registered two services that can provide contact information to the system. These contact records could contain phone numbers, email address, physical addresses, IM addresses, social networking profiles, or any other identifying information about a contact. There are many remote data sources available that contain this information, and could be a remote IM network, social network, email service, or remote contacts database. The system will inspect information retrieved for a single user, and apply business rules for determining if these contacts are the same and should be merged into a common view within the application 115 on the mobile device 110. However, the relationship and merge of these contacts is stored as a form of metadata, rather than an actual merged dataset, in order to preserve the integrity of the source data. When this view is requested by the end user who through the application 115 on the mobile device 110, the system will combine the local data and metadata into a unified view and send the combined data records to the application 115. In many cases, the view can be combined and stored in a temporary database or in memory cache, for quick retrieval by the delivery server 210. However, one of the features of this system is the ability to store and accumulate the associated metadata irrespective of the combined view and the storage of the local source data that was retrieved from the remote data source 400, and the ability of the system to retrieve the data from the remote data source 400 and develop the merged viewed based on the accumulated metadata.

Another specific example of accumulated metadata within the system is property that a record has been viewed or deleted by the end user within the application 115. In this example, the local data from the local database 230 has been provided to the application client 115 on the mobile device 110. Once the user has viewed or deleted the record, this metadata is captured by the application 115 and then stored by the delivery server 210 within the metadata database 240. This “record deleted” metadata, for instance, is stored with a reference to the local data stored in the local database 230, by way of referencing the local primary key. When the delivery server 210 creates a combined view for the application 115, it can remove the deleted record using the metadata as an indicator the record has been deleted by the end user and should not be viewable on the device. In this way, the system can provide additional views of the data irrespective of the remote data source 400.

As a specific example, an end user using the application 115 views a data record within the application. The user indicates this data record or user is a “favorite” and creates a favorite metadata attribute, which is stored in the delivery platform 200. Future views provided by the delivery server 210 to the application 115, using the metadata database 240 and local database 230, can tag specific records as “favorite” for a particular end user using the application 115. In this way, a set of favorite records can be displayed or presented differently within the application 115, without changing the records in the remote data source 400.

Various additional system rules or user behavior can result in accumulated metadata in the system, and should not be restricted to these specific examples.

As requested by the application 115 through a data request message 510, a connection request 500 or a similar request, the delivery server 210 provides data to the application 115 by the data response message 515. This data response message contains a merged view of data from both the local database 230 and the metadata database 240, providing a unique view of the data to the application 115 connected to the delivery platform 200.

Once the data response message 515 containing viewable data has been made available to the application 115, the application 115 can render the information in a variety of ways, specific to the specific needs of the application and context of the data view.

The user, by way of the application 115, interacts with the application 115 and associated data, and can perform a variety of actions within application screens, lists, and menus to generate metadata for use within the system. These actions will trigger the accumulation of metadata within the system, and is associated with specific data sets stored within the system.

While interacting with the system, accumulated metadata is frequently stored which modifies the view available to the application 115 from the delivery server 210. In no way does the application 115 edit or change information in the local database 230, directly or indirectly.

As part of this system, the delivery platform 200 can also cache or pre-determine the data view, comprised of records in the local database 230 and the metadata database 240. This cached data view can be recalculated at any point based on the underlying source data.

What is claimed is:

1. A delivery platform for delivering data from a remote data source to an application on a mobile device, the application requesting the data, the delivery platform comprising:
a delivery server, wherein the delivery server retrieves the data from the remote data source in response to a data request message received from the application;
a local database coupled to the delivery server, wherein the delivery server stores the retrieved data in the local database and the application does not have direct access to alter data stored in the local database; and
a metadata database coupled to the delivery server, wherein the delivery server stores metadata about the retrieved data in the metadata database;
wherein the delivery server delivers a data request response to the application, the data request response including a view of the retrieved data based on the retrieved data stored in the local database and on the metadata stored in the metadata database.

2. The delivery platform of claim 1 wherein, in order to retrieve the data from the remote data source, the delivery server makes a remote data call to the remote data source and, in response, receives a remote data response that includes the retrieved data.

3. The delivery platform of claim 2 wherein the remote data call and remote data response are made according to at least one of HTTP, TCP, UDP, RMI and JMS protocols.

4. The delivery platform of claim 2 wherein the remote data response formats the retrieved data according to at least one of XML and JSON protocols.

5. The delivery platform of claim 2 wherein the remote data call and remote data response are synchronous.

6. The delivery platform of claim 5 wherein the data request message and the data request response are asynchronous.

7. The delivery platform of claim 5 wherein the data request message and the data request response between the application and the delivery system, are decoupled from the remote data call and remote data response between the delivery system and the remote data source.

8. The delivery platform of claim 1 wherein the retrieved data stored in the local database is refreshed from the remote data source without having received a new data request message from the application.

9. The delivery platform of claim 1 wherein the retrieved data includes at least one of images, videos, news articles and blog posts.

10. The delivery platform of claim 1 wherein the retrieved data is stored in the local database and identified by a unique key inferred from the retrieved data.

11. The delivery platform of claim 10 wherein the unique key is based on at least one of a data source identifier, a user identifier, a timestamp, a subject text, a message text or a record id from the remote data source.

12. The delivery platform of claim 10 wherein the unique key is produced by using a hash function.

13. The delivery platform of claim 1 wherein the delivery server further receives a session metadata message from the application, the session metadata message including session metadata accumulated by the application.

14. The delivery platform of claim 13 wherein the session metadata includes metadata for at least one of viewing a record, merging a record, deleting a record, a message associated with a record, associations between records, keywords for a record, and attributes of a record.

15. The delivery platform of claim 1 wherein the metadata indicates a relationship between data received from at least two different remote data sources.

16. The delivery platform of claim 1 where the local database and metadata database are implemented as a single database.

17. The delivery platform of claim 1 further comprising:
an identity service, to manage authentication of the application to the remote data source.

18. The delivery platform of claim 17 wherein the application registers the remote data source with the delivery platform.

19. A method for delivering data from a remote data source to an application on a mobile device, the application requesting the data, the method comprising:
receiving a data request message from the application;
in response to the data request message, retrieving the data from the remote data source;
storing the retrieved data in a local database, wherein the application does not have direct access to alter data stored in the local database;
storing metadata about the retrieved data in a metadata database; and
delivering a data request response to the application, the data request response including a view of the retrieved data based on the retrieved data stored in the local database and on the metadata stored in the metadata database.

20. A non-transitory computer readable medium storing instructions that, when executed on a computer system, cause the computer system to carry out a method for delivering data from a remote data source to an application on a mobile device, the application requesting the data, the method comprising:
receiving a data request message from the application;
in response to the data request message, retrieving the data from the remote data source;
storing the retrieved data in a local database, wherein the application does not have direct access to alter data stored in the local database;
storing metadata about the retrieved data in a metadata database; and
delivering a data request response to the application, the data request response including a view of the retrieved data based on the retrieved data stored in the local database and on the metadata stored in the metadata database.
